(19) United States
(12) Patent Application Publication
(10) Pub. No.: US 2013/0115331 A1
(43) Pub. Date: May 9, 2013

(54) ALKYL DIMETHICONE CROSSPOLYMER ADDITIVE TO CHEWING GUM AND CHEWING GUM HAVING ALKYL DIMETHICONE CROSSPOLYMER

(71) Applicant: Michael E. Silver, Holland, MI (US)

(72) Inventor: Michael E. Silver, Holland, MI (US)

(21) Appl. No.: 13/586,833

(22) Filed: Aug. 15, 2012

Related U.S. Application Data
(60) Provisional application No. 61/555,012, filed on Nov. 3, 2011.

(51) Int. Cl. A23G 4/06

(52) U.S. Cl. 426/4

(57) ABSTRACT

An additive for gum comprising formulations of alkyl dimethicone crosspolymer, which is added to the gum formulations, compositions and products to reduce adhesion of the chewed gum to surfaces and to improve the aesthetic and manufacturing process characteristics of the gum. Gum having the additive is likewise disclosed as are methods of preparing the additives, as well as methods of using the gum having the additives.

### CROSS-REFERENCE TO RELATED APPLICATION

This application claims priority from U.S. Prov. Pat. App. Ser. No. 61/572,831 entitled “ALKYL DIMETHICONES ADDITIVE TO CHEWING GUM AND CHEWING GUM HAVING ALKYL DIMETHICONE” filed Aug. 26, 2011, and also claims priority from U.S. Prov. Pat. App. Ser. No. 61/555,012 entitled “ALKYL DIMETHICONE CROSSPOLYMER ADDITIVE TO CHEWING GUM AND CHEWING GUM HAVING ALKYL DIMETHICONE CROSSPOLYMER” filed Nov. 3, 2011, the entire disclosure of each of which is hereby incorporated in their entirety.

### BACKGROUND OF THE DISCLOSURE

1. Field of the Disclosure

The present disclosure relates in general to chewing gum, and more particularly, to an additive to chewing gum compositions and products to produce reduced adhesion of the chewed gum to surfaces and to improve the aesthetic and manufacturing process characteristics of the gum. As used herein, the term “chewing gum”, “gum”, and “bubble gum” are utilized interchangeably to reference conventionally known gum products, formulations and compositions that are chewed by consumers. It will be understood that “gum” shall refer to any and all such products and shall include “chewing gum”, “bubble gum”, “medicated gum products”, among any other types of gum products. The terms are not limited to any particular class, type, or brand of gum products, and have applicability across the spectrum thereof.

2. Background Art

Conventional gum products, once chewed, pose a tremendous and growing waste problem due to their often inappropriate discard into the environment (pavement, sidewalks, bottom surfaces of desks and chairs, train platforms, etc.). Next to discarded cigarette butts, chewing gum waste or chewed cud (the chewed remains of chewing gum that are discarded) is thought to be the second largest littering item in the world. Annually, there are close to 1 million metric tons of chewing gum produced. The chewed cud fiercely adheres to just about any surface it comes into contact with and requires a good deal of labor to remove it. There is growing gum waste backlash and taxation efforts to deal with gum waste in the US, UK, Canada, and Australia. Cities and counties spend large sums to clean gum off the streets and sidewalks. According to a United Kingdom government report, currently about £150 million is spent annually by local authorities on chewing gum cleanup. San Francisco, Calif. is currently considering adding a fee to the purchase price of chewing gum and other items that end up on streets and sidewalks to offset the rising cost of clean-up.

Chewing gum generally includes of a gum base which is most often water insoluble, a water soluble portion (this includes sweeteners including but not limited to sugar, syrup, or sorbitol for sugarless gum), and flavors. The water soluble portion dissipates with a portion of the flavor over a period of time during the chewing. The gum base portion is retained in the mouth throughout the chew.

In a conventional chewing gum manufacturing process, a double arm Sigma blade mixer is often used to mix (grind) chewing gum base ingredients. Gum base typically comprises, but is not limited to, elastomers such as butyl rubber, styrene-butadiene, poly iobutylene, polyisopropene, polyvinyl acetate, vinyl acetate/vinyl laurate copolymer, cis-polypropylene containing a grafted malic anhydride that is further reacted with a methoxypolyethylene glycol (as is disclosed in U.S. Pat. No. 8,211,980 issued to Cosgrove et al, the entirety of which is hereby incorporated by reference), and terpolymers such as polyvinylacetate/vinyl alcohol/elastic polymer with Tg lower than that of polyvinylacetate (as is disclosed in U.S. Pat. App. Pub. No. 2012/0128818 published to Paffumi et al, the entirety of which is hereby incorporated by reference). Other ingredients can also be added to the gum base, including but not limited to terpene resins and rosin resins which may optionally be esterfied or hydrogenated and function as plasticizers to the elastomers; monoglycerides, lecithins, hydrogenated vegetable oils, waxes, and mineral fillers such as calcium carbonate or talc.

The gum base, the water soluble portion, and the flavors are mixed about 5-20 minutes to manufacture the gum. Grinding of the chewing gum composition is typically a difficult process because of the tendency for the gum to stick to the grinding apparatus. The heated, warm, dough-like gum mass is removed from the mixer and added to a kneader from which it is forced or sheeted into a ribbon or rope to be formed into chunks, pellets, tabs, or sticks. After cooling, pellet gum is coated. Other forms are wrapped in high speed wrapping machines. During these processes, the sheet of gum is often dusted with powdered sugar and the like to prevent it from adhering to the rollers.

A number of prior art patents and publication disclose additives and/or modifications to chewing gum and bubble gum formulations for purposes of reducing the adhesion of the chewed cud to outside surfaces (i.e. surfaces where improperly discarded gum is often found). For example, as far back as 1956, U.S. Pat. No. 2,761,782 issued to Leonard discloses the use of Dow Corning 200 fluids (polydimethylsiloxanes) from 1-25% to produce low adhesion silicone-containing chewing gum. U.S. Pat. App. Pub. No. 2005/0112234 published to Patel et al discloses the use of a gum base that does not include filler, resulting in gum cuds that are said to have reduced adhesion. U.S. Pat. App. Pub. No. 2007/0042079 published to Miladinov et al discloses a non-stick inducing component selected from fatty acids; monoglycerides, diglycerides, and triglycerides of fatty acids; natural fats; esters of monoglycerides and diglycerides; glycerol esters of fatty acids; animal fats; fatty esters of sugars; esters of alcohols; phospholipids and combinations thereof. U.S. Pat. App. Pub. No. 2007/0042078 also published to Miladinov et al discloses inclusion of at least one free-radical generator to increase biodegradability. U.S. Pat. App. Pub. No. 2008/0145477 published to Shen et al discloses addition of delayed-release modification agent selected from emulsifiers, surfactants, enzymes and alkalis and mixtures thereof. U.S. Pat. No. 5,945,143 issued to Bunczek and U.S. Pat. No. 6,190,706 issued to Bunczek et al disclose the use of alkyl dimethicones as additives to reduce the adhesion of chewed gum to environmental surfaces. U.S. Pat. App. Pub. No. 2012/0128818 identified above discloses the use of terpolymers such as polyvinylacetate/vinyl alcohol/elastic polymer with Tg lower than that of polyvinylacetate. U.S. Pat. No. 8,211,980 identified above discloses the use of cis-polypropylene containing a grafted malic anhydride that is further reacted with a methoxypolyethylene glycol. It is understood that this has been commercialized as Rev7™ gum. Each of the foregoing patents are incorporated by reference herein in their entirety.

Despite these efforts, there have not been widely successful commercial applications of either a gum base or an additive to a typical gum formulation that sufficiently reduces adhesion of the discarded chewed cud from surfaces such as cement, asphalt, and carpet, that does not also have deleterious effects on the aesthetic properties (including, but not limited to, taste, chewability, duration of flavor), negative effects on the manufacture process properties of the gum and/or negative effects on the economics of the manufacture and sale of chewing gum products.

In particular, it has been determined that alkyl dimethicone additives of the type disclosed in U.S. Pat. Nos. 5,945,143 and 6,190,706 above, while yielding reduced adhesion of the chewed cud to environmental surfaces such as cement and carpet, also leave considerable residue of the additive on the environmental surface upon removal of the chewed cud. Additionally, these additives also act as plasticizers to noticeably soften the cud and yield dramatically altered chewability, both undesirable outcomes.

Thus, there remains a need for a commercially viable additive to chewing gum products that provides for reduced stickiness or non-stick properties to any dental or orthodontic device contained in the oral cavity; any surface on a human or animal body including the skin, such as the skin on the face, and hair; and any surface external to a human or animal body, such as the surface of pavements, sidewalks, roadways, cement, concrete, brick, glass, wood, plastic, stone, furniture, carpeting, the soles of footwear including shoes or sneakers, cardboard, paper, metal, and surfaces of porous nature to which chewed gum stick and is difficult to remove, and in addition yields no deleterious effects on the aesthetic and environmental characteristics of the gum and/or on its manufacturing process.

Additionally, there remains a need for a commercially viable additive to chewing gum products that provides for reduced stickiness or non-stick properties that yields no or less plasticization of the cud compared to alkyl dimethicone additives and in addition yields advantageous effects on the aesthetic and environmental characteristics of the gum (including but not limited to elongated release of flavor components) and/or on its manufacturing process.

### SUMMARY OF THE DISCLOSURE

The disclosure is directed to a gum formulation which includes at least one alkyl dimethicone crosspolymer as an additive thereto in an amount sufficient to reduce the adhesion of the chewed gum to surfaces. Such surfaces include without limitation, for example, the following: any surface in the oral cavity such as the surface of a tooth or the surface of any dental or orthodontic device contained in the oral cavity; any surface on a human or animal body including the skin, such as the skin on the face, and hair; and any surface external to a human or animal body, such as the surface of pavements, sidewalks, roadways, cement, concrete, brick, glass, wood, plastic, stone, furniture, carpeting, the soles of footwear including shoes or sneakers, cardboard, paper, metal, and surfaces of porous nature to which chewed gum stick and is difficult to remove. This includes all surfaces that the gum might come into contact with during the manufacturing and packaging processes. The alkyl dimethicone crosspolymer may be added to the chewing gum formulation at any point in the manufacturing process of the chewing gum.

In some formulations, the additive having at least one alkyl dimethicone crosspolymer also does not dramatically change the chewability of the gum and also yields a substantially reduced amount of residue on the environmental surface to which the chewed cud was pressed upon removal of the cud relative to alkyl dimethicone additives that are not intentionally crosslinked.

In some formulations, the additive having at least one alkyl dimethicone crosspolymer results in an elongated duration of flavor sensation during the chewing of the gum.

Said additives may also be advantageous to the manufacturing process of the gum in that they can be expected to reduce the tendency of the gum to stick to mixing blades and rollers.

In another aspect of the disclosure, the disclosure is directed to an additive which can be introduced into gum formulations to enhance the adhesion reduction properties of the gum formulations, as well as aesthetic characteristics of the gum, and to enhance properties for improved manufacturability.

More specifically, the disclosure is directed to gum for chewing comprising a gum base and an additive. The additive comprises at least one alkyl dimethicone crosspolymer, which are defined as polymeric compounds having Formula I=(R¹R²R³SiO)([CH₃]₂SiO)ₓ(CH₃R⁴SiO)_{y}(CH₃XSiO)_{z}(SiR⁵R⁶R⁷), where R¹, R², R³, R⁴, R⁵, R⁶, R⁷ can be an alkyl chain from 1-50 carbons in length and is at least one of linear, branched, saturated, or unsaturated; X can be any functionality that serves to crosslink one polymer chain of Formula I to another polymer chain of Formula I, and is preferably but not limited to (—CH₂CH₂)(CH₃)₂SiO_{1/2}; x≧1; y≧1; z>0.

In a preferred embodiment, z is ≧0.1 and ≦2.1. In another preferred embodiment, the organization of said alkyl dimethicone crosspolymers is at least one of random or blocked with respect to the ([CH₃]₂SiO), (CH₃R⁴SiO), and (CH₃XSiO) units.

The siloxane backbone may be branched via incorporation of one or more (CH₃SiO₂) and/or (SiO₃) units. Additionally, a portion of the alkyl dimethicone crosspolymer may be cyclic in nature.

In a preferred embodiment, the additive comprises between 0.01% to 90% by mass of the gum. In one such embodiment, the additive comprises between 0.05% to 40% by mass of the chewing gum. More preferably, the additive comprises between 0.5% and 8% by mass of the chewing gum.

In another preferred embodiment, the gum includes at least one water soluble portion. In one such embodiment, the at least one water soluble portion comprises at least one of the group consisting of: sugar, syrup, or aspartame, saccharin, sucralose, sorbitol, natural and artificial sweeteners.

In another preferred embodiment, the gum base further includes at least one of the group consisting of: terpene resins, rosin resins, esterfied or hydrogenated and function as plasticizers to the elastomers; monoglycerides, lecithins, hydrogenated vegetable oils, waxes, mineral fillers, calcium carbonate and talc.

In another preferred embodiment, the gum further includes at least one flavor. In such a preferred embodiment, the at least one flavor is selected from the group consisting of: natural and artificial flavorings, spearmint, peppermint, and fruit flavors.

In yet another aspect of the disclosure, the disclosure is directed to a method of formulating a gum for chewing. The method comprises the steps of: providing at least one gum base; providing an additive comprising at least one alkyl dimethicone crosspolymer, which are defined as polymeric compounds having Formula I=(R1R2R3SiO)([CH3]2SiO)x(CH3R4SiO)y(CH3XSiO)z(SiR5R6R7), where R1, R2, R3, R4, R5, R6, R7 can be an alkyl chain from 1-50 carbons in length and is at least one of linear, branched, saturated, or unsaturated; X can be any functionality that serves to crosslink one polymer chain of Formula I to another polymer chain of Formula I, and is preferably but not limited to (—CH2CH2)(CH3)2SiO1/2; x≧1; y≧1; z>0; and mixing the at least one gum base with the additive.

In a preferred embodiment, the method further includes the step of providing at least one water soluble portion. Additionally, the step of mixing further comprises the step of mixing the at least one water soluble portion.

In another preferred embodiment, the method further comprises the step of providing at least one flavor. Additionally, the step of mixing further comprises the step of mixing the at least one flavor.

### BRIEF DESCRIPTION OF THE DRAWINGS

The disclosure will now be described with reference to the drawings wherein:

FIG. 1a of the drawings is a photographic representation of cement showing additive residue left behind on the cement upon removal of chewed cud under a 4% formulation of Example 1;

FIG. 1b of the drawings is a photographic representation of cement showing additive residue left behind on the cement upon removal of chewed cud under a 4% formulation of Example 6d; and

FIG. 1c of the drawings is a photographic representation of cement showing additive residue left behind on the cement upon removal of chewed cud under a 4% formulation of Example 6e.

### DETAILED DESCRIPTION OF THE DISCLOSURE

While this disclosure is susceptible of embodiment in many different forms, there is described herein in detail a specific embodiment with the understanding that the present disclosure is to be considered as an exemplification and is not intended to be limited to the embodiment illustrated.

As used herein, the term “surface”, when used in connection with non-stick properties, refers to any surface with which chewed comes into contact and/or any surface with which the gum comes into contact during the manufacturing and packaging processes. Such surfaces include without limitation, for example, the following: any surface in the oral cavity such as the surface of a tooth or the surface of any dental or orthodontic device contained in the oral cavity; any surface on a human or animal body including the skin, such as the skin on the face, and hair; and any surface external to a human or animal body, such as the surface of pavements, sidewalks, roadways, cement, concrete, brick, glass, wood, plastic, stone, furniture, carpeting, the soles of footwear including shoes or sneakers, cardboard, paper, metal, and surfaces of porous nature to which chewed gum stick and is difficult to remove.

As used herein, the term “reduced adhesion” means the chewed gum exhibits reduced adhesion to surfaces compared to the same gum that is absent of alkyl dimethicone crosspolymer.

As used herein, “alkyl dimethicone crosspolymers” are defined as polymeric compounds having Formula I=(R¹R²R³SiO)([CH₃]₂SiO)ₓ(CH₃R⁴SiO)_{y}(CH₃XSiO)_{z}(SiR⁵R⁶R⁷), where R¹, R², R³, R⁴, R⁵, R⁶, R⁷ can be an alkyl chain from 1-50 carbons in length and may be linear, branched, saturated, or unsaturated; X can be any functionality that serves to crosslink one polymer chain of Formula Ito another polymer chain of Formula I, and is preferably but not limited to (—CH₂CH₂)(CH₃)₂SiO_{1/2}; x≧1; y≧1; z>0; where z is preferably ≧0.1 and ≦2.1; the organization of said alkyl dimethicone crosspolymers may be either random or blocked with respect to the ([CH₃]₂SiO), (CH₃R⁴SiO), and (CH₃XSiO) units; the siloxane backbone can be branched instead of linear via incorporation of one or more (CH₃SiO₂) and/or (SiO₃) units; crosslinking can be present induced via any of the means known to those practiced in the art of silicone chemistry and may be achieved by but not limited to the following means: (reaction of Si—H functions with any compound that contains two or more vinyl or terminal olefin functions such as but not limited to 1,3-divinyltetramethyldisiloxane; conversion of Si—H functionalities to Si—OH functionalities followed by condensation of Si—OH with Si—OH or Si—OH with Si—OR (where R=any hydrocarbyl) to yield Si—O—Si crosslinks; inclusion of ternary (T) RSiO_{3/2} (where R=any hydrocarbyl) or quaternary (Q) SiO_{4/2} functionalities); and peroxide induced curing. Desirably, an alkyl dimethicone crosspolymer may have an LSB value ≧3 and ≦17, where LSB is lipophillic-silophilic balance and is defined as (MMₛᵢₗ/MM)*20, where MMₛᵢₗ is the molar mass of that portion of an alkyl dimethicone that possesses internal or end-capping units with all R′^{S}=CH₃, and MM is the molar mass of the entire compound. More desirably, an alkyl dimethicone crosspolymer may have an LSB value ≧5 and ≦15. More desirably, an alkyl dimethicone crosspolymer may have and LSB value ≧7 and ≦13.

As will be explained and shown below through the various examples, the reduced adhesion of chewed gum with a subsequent lack of deleterious effects such as dramatic softening of the cud or a leaving behind of a substantial amount of additive residue on the surface to which the chewed cud was affixed and then removed and desired effects such as the elongation of flavor sensation during chewing is achieved by inclusion of one or more alkyl dimethicone crosspolymers to the gum.

It will be understood that the gum of the present disclosure may comprise any formulation of gum. Generally, the gum includes a gum base, a water soluble portion and flavors.

Chewing gum generally consists of a gum base which is most often water insoluble, a water soluble portion and flavors. It will be understood that the water soluble portion dissipates with a portion of the flavor over a period of time during the chewing. The gum base portion is retained in the mouth throughout the chew.

Gum base typically comprises, but is not limited to, elastomers such as butyl rubber, styrene-butadiene, polyisobutylene, polyisopropene, polyvinyl acetate, vinyl acetate/vinyl laurate copolymer, cis-polypropylene containing a grafted malic anhydride that is further reacted with a methoxypolyethylene glycol (as is disclosed in U.S. Pat. No. 8,211,980 issued to Cosgrove et al, identified above), and terpolymers such as polyvinylacetate/vinyl alcohol/elastic polymer with Tg lower than that of polyvinylacetate (as is disclosed in U.S. Pat. App. Pub. No. 2012/0128818 published to Paffumi et al, identified above).

In addition to the foregoing, the gum base may further include, but not be limited to terpene resins and rosin resins which may optionally be esterfied or hydrogenated and function as plasticizers to the elastomers; monoglycerides, lecithins, hydrogenated vegetable oils, waxes, and mineral fillers such as calcium carbonate or talc.

The water soluble portion may comprise sweeteners including but not limited to sugar, syrup, or aspartame, saccharin, sucralose, sorbitol, among other natural and artificial sweeteners. The flavors may comprise both natural and artificial flavorings, such as spearmint, peppermint, fruit flavors, among others. Indeed, the disclosure is not limited to any particular gum base, water soluble portion and flavors.

The alkyl dimethicone crosspolymers of present disclosure include cross-linking to yield preferably liquids or gels. Such alkyl dimethicone crosspolymers include alkyl dimethicone crosspolymers that are substantially dilute with respect to crosslinking functionalities. It is well understood by those of ordinary skill in the art of silicone-type polymers that cross-linked liquid and gel polymers of the silicone variety are often mostly liquid by weight, and yet they possess a three-dimensional cross-linked network within the liquid. In other words, alkyl dimethicone crosspolymers contain a crosslinked “scaffolding” therewithin, a three dimensional “web” or “net” dissolved within and extending throughout the material. Such a network (a scaffolding) within the liquid or gel additive, it is believed, yields superior performance to alkyl dimethicone additives absent of cross-linking, superior performance including but not limited to a more complete release of the chewed cud from environmental surfaces, less of a plasticizing effect on the gum (less softening of the cud), and less of a residue of the additive left behind on the environmental surface upon removal of the chewed cud.

It is well understood that such crosslinking leads to an increased molecular weight and structural complexity of the alkyl dimethicone crosspolymer additive relative to alkyl dimethicone additive that is absent of crosslinking, and it is postulated that this yields a reduction of mobility of the alkyl dimethicone crosspolymer additive within the gum base relative to alkyl dimethicone additive that is absent of crosslinking, leading to increased affinity of the alkyl dimethicone crosspolymer additive for the gum base (resulting in less residue of the additive left behind on the environmental surface upon removal of the chewed cud), more complete release of the chewed cud from environmental surfaces, and less plasticization of the cud relative to alkyl dimethicone additive that is absent of crosslinking.

In general, it is preferred that an individual alkyl dimethicone crosspolymer may be present in an amount from about 0.01% to about 90% by weight of the entire chewing gum formulation. Desirably, an individual alkyl dimethicone crosspolymer may be present in an amount from about 0.05% to about 40% by weight of the entire chewing gum formulation. More desirably, an individual alkyl dimethicone crosspolymer may be present in an amount from about 0.05% to about 10% by weight of the entire chewing gum formulation. Still more desirably, an individual alkyl dimethicone crosspolymer may be present in an amount from about 0.5% to about 8% by weight of the entire chewing gum formulation.

The manner in which the chewing gum formulation components are mixed, including the alkyl dimethicone crosspolymer, can be performed using any number of different processes using specific as well as standard apparatuses known to those of ordinary skill in the art. It will be understood that the alkyl dimethicone crosspolymer can be introduced at any point in the process of making gum, for example, during the mixing stages of the gum base, the water soluble components and the flavoring. It is also understood that the alkyl dimethicone crosspolymer can be added to any one of the gum base, the water soluble components and the flavoring during the production of the individual component, or after production of the individual components (i.e., prior to the mixing of the components together). In other embodiments, the alkyl dimethicone crosspolymer can be added after all of the constituents have been mixed together.

The features and advantages of the formulations in the disclosure are more fully shown by the following examples which are provided for purposes of illustration, and are not to be construed as limiting in any way. For example, the disclosure is not limited in any manner to the preparation of raw materials, the particular additives chosen, the particular gum base or chewing gum formulation that is utilized or the particular quantities of the constituents, among others.

Experimental Procedures

A plurality of raw materials were prepared to complete the formulations. These raw materials and the preparation thereof are disclosed for illustrative purposes, and the disclosure is not limited to such formulations and preparations as specifically disclosed.

1. Preparation of Silanic Hydrogen Containing Intermediate

Silicone intermediates of the type used to make the compounds disclosed in the present disclosure are well known to those skilled in the art of platinum catalyzed hydrosilation reactions of terminal olefinic compounds. These intermediates conform to the following structure (the Si—H containing units are randomly distributed):

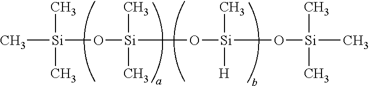

These intermediates were prepared from equilibration of octamethylcyclotetrasiloxane and/or decamethylcyclopentasiloxane, hexamethyldisiloxane, and either tetramethylcyclotetrasiloxane [HSiCH₃O]₄ or Me₃SiO-(MeHSiO)₅₀—SiMe₃, with tonsil acid clay (1 g per 100 g of reaction mixture) at 80° C. for a minimum of eight hours, filtered, and stripped of volatiles at 175° C. and 0.01 mm Hg pressure. For example, Me₃SiO-[Me₂SiO]₁₈-[MeHSiO]₉—SiMe₃ and Me₃SiO-[Me₂SiO]₁₂₀-[MeHSiO]₂₂—SiMe₃ were prepared and their structures confirmed via Si—H analysis, proton NMR spectroscopy, and molecular weight determination via gel permeation chromatography.

2. Alpha Olefins

The Alpha olefins used were 1-dodecene and 1-docosene, both available from a variety of sources which are known to those of ordinary skill in the art.

3. Hydrosilylation Reactions

All hydrosilylation reactions were performed without solvent in a 150 mL beaker equipped with a 1 inch magnetic stir bar and heated in a mineral oil bath as specified below. The hydrosilation reaction used to make the compounds of the present disclosure is well known to those of ordinary skill in the art, and one such example is available in PCT Publication No. WO 86/05411, entitled “Silicone Alkylene Oxide Copolymers as Foam Control Agents”, published to Paul Austin with specific reference to p. 19 thereof. The entirety of this PCT publication is hereby incorporated in its entirety by reference. A variety of platinum catalysts are known and are readily available to those practiced in the art of hydrosilation, and include soluble platinum compounds (homogeneous catalysts) and insoluble platinum on carbon (heterogeneous catalysts). The platinum catalyst employed was 2-3% platinum-cyclovinyl-methylsiloxane complex (CAS #68585-32-0) supplied by United Chemical Technologies, Inc. Sufficient catalyst was used to achieve a platinum concentration of 5-50 ppm for all reactions. Reaction times were from 1-24 hours. If desired, these reactions can be performed in a pressurizeable steel reactor and residual (unreacted) Si—H can be further minimized by introducing 40 psi of ethylene at the end of the above mentioned reaction time and maintaining heat and stirring for an additional hour. Additionally, if desired, these reactions can be performed using fixed bed catalyst technology to achieve very low platinum concentrations.

Experimental Preparations and Test Results

A number of different examples were prepared and tested for purposes of determining their efficacy as additives. The individual examples are not to be deemed limiting, but should be seen as illustrative of the principles underlying the instant disclosure. Examples 1-5 are non-crosslinked alkyl dimethicones that were prepared and tested (Tests 1-3) in order to find what has been termed a “best performing” non-crosslinked alkyl dimethicone to compare to the alkyl dimethicone crosspolymers prepared under the present disclosure. The “best performing” non-crosslinked alkyl dimethicone additive was discovered by preparing non-crosslinked alkyl dimethicone additives that probed three-dimensional space defined by three axes: axis (1): LSB (lipophillic-silophilic balance); axis (2): D/D(R⁴) ratio [where D=(CH₃)₂SiO and D(R⁴)═(CH₃)R⁴SiO]; axis (3): R⁴ hydrocarbyl length. This allowed determination of the set of values for these three parameters that yielded a “best performing” non-crosslinked alkyl dimethicone additive that produced the best release of the chewed cud from cement and olefin carpet. Example 6 reveals alkyl dimethicone crosspolymers of the present disclosure and Test 4 illustrates their performance as additives to gum relative to the “best performing” non-crosslinked alkyl dimethicone. The test results clearly show that the alkyl dimethicone crosspolymers disclosed in the present disclosure have improved desirable performance characteristics relative to non-crosslinked alkyl dimethicone additives of the prior art, including the “best performing” non-crosslinked alkyl dimethicone mentioned above.

### Example 1

### Non-crosslinked alkyl dimethicone Me₃SiO-[Me₂SiO]₁₈-[MeRSiO]₉—SiMe₃ where R=(CH₂)₁₁CH₃

1-dodecene (14.86 g, 0.0883 mol) and silanic hydrogen intermediate Me₃SiO-[Me₂SiO]₁₈-[MeHSiO]₉—SiMe₃ (20.0 g, 0.00972 mol) were combined in a 150 mL beaker equipped with a 1 inch magnetic stir bar and heated and stirred in an 85° C. mineral oil bath. 5.8 μL of catalyst was added when the contents of the beaker reached 82° C., causing a very rapid exotherm to 155° C. The reaction was then allowed to stir in the 85° C. oil bath for 1 hour. The final product was a clear colorless liquid having a viscosity of approximately 140 cSt at 25° C. Proton NMR and IR spectra of the product were consistent with the expected structure.

### Example 2

### Non-crosslinked alkyl dimethicone Me₃SiO-[Me₂SiO]₁₈-[MeRSiO]₉—SiMe₃ where R=(CH₂)₂₁CH₃

1-docosene (25.31 g, 0.0820 mol) and silanic hydrogen intermediate Me₃SiO-[Me₂SiO]₁₈-[MeHSiO]₉—SiMe₃ (18.58 g, 0.00911 mol) were combined in a 150 mL beaker equipped with a 1 inch magnetic stir bar and heated and stirred in an 85° C. mineral oil bath. 7.3 μL of catalyst was added when the contents of the beaker reached 84° C., causing a very rapid exotherm to 143° C. The reaction was then allowed to stir in the 85° C. oil bath for 1.5 hours. The final product was a low melting wax (mp 42.6-43.6° C.). Proton NMR and IR spectra of the product were consistent with the expected structure.

### Example 3

### Non-crosslinked alkyl dimethicone Me₃SiO-[Me₂SiO]₁₂₀-[MeRSiO]₂₂—SiMe₃ where R=(CH₂)₁₁CH₃

1-dodecene (7.132 g, 0.0424 mol) and silanic hydrogen intermediate Me₃SiO-[Me₂SiO]₁₂₀-[MeHSiO]₂₂—SiMe₃ (20.00 g, 0.00193 mol) were combined in a 150 mL beaker equipped with a 1 inch magnetic stir bar and heated and stirred in an 85° C. mineral oil bath. 6.0 μL of catalyst was added when the contents of the beaker reached 84° C., causing a very rapid exotherm to 140° C. The reaction was then allowed to stir in the 85° C. oil bath for 1 hour. The final product was a clear colorless liquid. Proton NMR and IR spectra of the product were consistent with the expected structure.

### Example 4

### Non-crosslinked alkyl dimethicone Me₃SiO-[Me₂SiO]₁₂₀-[MeRSiO]₂₂—SiMe₃ where R=(CH₂)₂₁CH₃

1-docosene (13.076 g, 0.0424 mol) and silanic hydrogen intermediate Me₃SiO-[Me₂SiO]₁₂₀-[MeHSiO]₂₂—SiMe₃ (20.00 g, 0.00193 mol) were combined in a 150 mL beaker equipped with a 1 inch magnetic stir bar and heated and stirred in an 126° C. mineral oil bath. 8.0 μL of catalyst was added when the contents of the beaker reached 118° C., causing a mild exotherm to 120.5° C. The reaction was then allowed to stir in the 126° C. oil bath for 2 hours during which time the opaque reaction mixture became clear and colorless. The final product was low melting wax (mp 31.6-32.2° C.) which melted rapidly at body temperature. Proton NMR and IR spectra of the product were consistent with the expected structure.

### Example 5

### Non-crosslinked alkyl dimethicone Me₃SiO-[Me₂SiO]₁₅₀-[MeRSiO]₂₂—SiMe₃ where R=(CH₂)₁₁CH₃

1-dodecene (5.884 g, 0.0350 mol) and silanic hydrogen intermediate Me₃SiO-[Me₂SiO]₁₅₀-[MeHSiO]₂₂—SiMe₃ (20.03 g, 0.00159 mol) were combined in a 150 mL beaker equipped with a 1 inch magnetic stir bar and heated and stirred in an 85° C. mineral oil bath. 6.0 μL of catalyst was added when the contents of the beaker reached 85° C., causing a very rapid exotherm to 130.5° C. The reaction was then allowed to stir in the 85° C. oil bath for 1 hour. The final product was a clear colorless liquid. Proton NMR and IR spectra of the product were consistent with the expected structure.

Test I: Results for Non-Crosslinked Alkyl-Dimethicones as Release Agents for Chewed Chewing Gum to Find the “Best Performing” Non-Crosslinked Alkyl Dimethicone Additive.

A number of different test preparations were prepared to test the efficacy of the additive when applied to gum formulations. Below, the test procedure is shown and explained. Again, the disclosure thereof is not to be deemed as limiting, but to be exemplary and illustrative of the results associated with certain testing that was undertaken.

Procedure: The gum used for testing was Wrigley's Doublemint Gum sticks available from Wm. Wrigley Jr. Company of Chicago, Ill. (a wholly owned subsidiary of Mars Incorporated). Such a gum includes a gum base, a water soluble portion and flavors. For each additive tested, four sticks of gum were each cut into quarters and placed into a 150 mL beaker. Sufficient alkyl-dimethicone was then added to achieve a concentration of 4% by mass. The contents of the beaker were then heated to 120-125° C. in a mineral oil bath. The gum softened and the contents of the beaker were vigorously stirred with a spatula for 1-2 minutes so as to thoroughly mix the alkyl-dimethicone into the gum. The gum was then removed with a metal spatula and pressed into a pancake on a clean hard countertop and allowed to cool.

For each release test, an amount of gum equivalent to one stick of gum was chewed 20 minutes. The cud was then divided into halves, with one half immediately pressed into a piece of olefin carpet (melting point of carpet fibers 150-168° C.) and the other half pressed into the rough (unfinished) side of a cement patio block and then pressed multiple times over the course of an hour. The test samples were then allowed to sit at room temperature for two days, after which an attempt was made to remove each cud by pulling it off three times between pinched thumb and forefinger. Test results are in Table I.

A scale of n from minus ten to positive ten was used to judge release (ease of removal and amount left on substrate), with n=0 being the release performance for untreated gum (control). A positive n value means release from the substrate was easier than for untreated gum, with the amount of gum left behind on the substrate equal to 1/n times that left by untreated gum (visual estimate). A negative n value means release from the substrate was more difficult that for untreated gum, with the amount of gum left behind on the substrate equal to |n| times that left for untreated gum (visual estimate). The LSB of each release agent is included, with the value of 10 being assigned the designation of amphiphilic; the values 10>LSB>6 being assigned the designation of amphiphilic(lip); the values of 14≧LSB>10 being assigned the designation of amphiphilic(sil). The D/D(R) ratio of the alkyl dimethicone release agent is the ratio of the number of Me₂SiO units to the number of MeRSiO units where R is any alkyl group that is not methyl.

TABLE I
Release Test Results for various release agents at 4% by mass.

| | | | | Release | Release |
|---|---|---|---|---|---|
| | | D/D(R) | | Perf. on | Perf. on |
| Test | Release Agent | Ratio | LSB | Cement | Carpet |
| Ctrl | None | — | — | 0 | 0 |
| (A) | Paraffin wax (mp 57-63° C.) | 0 | 0 | −2 | −5 |
| (B) | Silcare 41M90 (C₃₀) wax | 0.6 | 2.76 | −3 | −6 |
| | M—D(C₃₀H₆₁)₅—D₃—M | | lipophilic | | |
| | (mp > 70° C.) | | | | |
| (C) | Silcare 41M80 (C₂₆) wax | 0.6 | 3.07 | −8 | −8 |
| | M—D(C₂₆H₅₃)₅—D₃—M | | lipophilic | | |
| | (mp 60° C.) | | | | |
| (D) | Silcare 41M65 (C₁₈) wax | 0.6 | 3.97 | −7 | −7 |
| | M—D(C₁₈H₃₇)₅—D₃—M | | lipophilic | | |
| | (mp 30° C.) | | | | |
| (E) | M—D₁₈—D(C₂₂H₄₅)₉—M wax | 2.0 | 6.28 | 0 | −4 |
| | (mp 43° C.) | | amphiphilic(lip) | | |
| (F) | M—D₁₈—D(C₁₂H₂₅)₉—M fluid | 2.0 | 8.45 | 9 | 5 |
| | | | amphiphilic(lip) | | |
| (G) | M—D₁₂₀—D(C₂₂H₄₅)₂₂—M wax | 5.45 | 10.55 | 2 | −2 |
| | (mp 32° C.) | | amphiphilic(sil) | | |
| (H) | M—D₁₂₀—D(C₁₂H₂₅)₂₂—M fluid | 5.45 | 12.91 | 4 | 0 |
| | | | amphiphilic(sil) | | |
| (I) | M—D₁₅₀—D(C₁₂H₂₅)₂₂—M fluid | 6.82 | 13.84 | −2 | −2 |
| | | | amphiphilic(sil) | | |
| (J) | 1,000 cSt Silicone oil | infin | 20 | −3 | −4 |
| | | | silophilic | | |

wherein, M = [(CH₃)₃SiO_{1/2}]; D = [(CH₃)₂SiO]; D(R) = [(CH₃)RSiO], R = alkyl other than CH₃; D(CₙH₂ₙ₋₁) = [(CH₃)(CₙH₂ₙ₋₁)SiO] and, wherein Silcare waxes are commercially available products of Clariant Corp.

The above results reveal that the M-D₁₈-D(C₁₂H₂₅)₉-M alkyl dimethicone (Example 1) used in test (F) was the “best-performing” non-crosslinked alkyl dimethicone gum release additive. However, there was a very obvious stain of this additive on the cement upon removal of the chewed gum, and the gum was noticeably softened by this additive to the point where it was easily possible to blow a bubble while chewing the gum (it was observed that a bubble couldn't be blown with Wrigley's Doublemint gum to which no alkyl dimethicone was added).

Test II: Finding an Effective Concentration in Gum for the “best performing” non-crosslinked alkyl dimethicone Me₃SiO-[Me₂SiO]₁₈-[MeRSiO]₉—SiMe₃ where R=(CH₂)₁₁CH₃ as a Release Agent for Chewed Chewing Gum

Procedure: The gum used for testing was Wrigley's Doublemint Gum sticks. For each concentration of Example 1 Me₃SiO-[Me₂SiO]₁₈-[MeRSiO]₉—SiMe₃ [R═(CH₂)₁₁CH₃] tested, four sticks of gum were each cut into quarters and placed into a 150 mL beaker. Sufficient alkyl-dimethicone was then added to achieve the concentration by mass indicated in Table II. The contents of the beaker were then heated to 120-125° C. in a mineral oil bath. The gum softened and the contents of the beaker were vigorously stirred with a spatula for 2 minutes so as to thoroughly mix the alkyl-dimethicone into the gum. The gum was then removed with a metal spatula and pressed into a pancake on a clean hard countertop and allowed to cool.

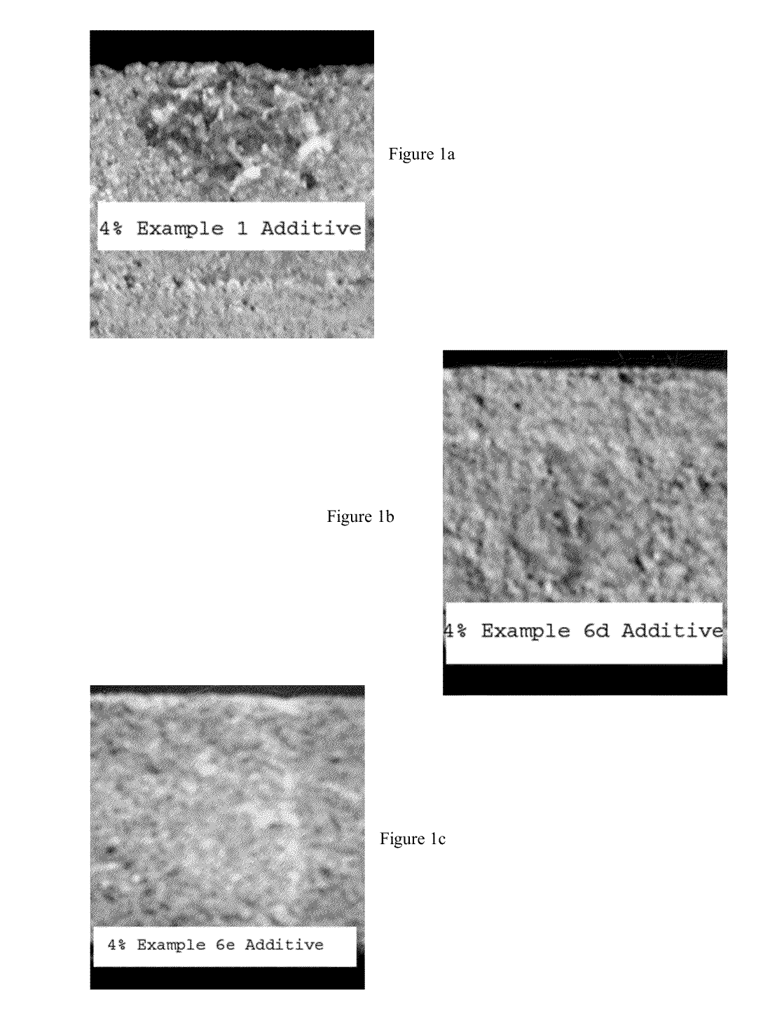

For each release test, an amount of gum equivalent to one stick of gum was chewed 20 minutes. The cud was then pressed into the rough (unfinished) side of a cement patio block and then pressed multiple times over the course of an hour. The test samples were then allowed to sit at room temperature for two days, after which an attempt was made to remove each cud by pulling it off three times between pinched thumb and forefinger. Test results are in Table II. And FIGS. 1a through 1c show pictures of the residue left on the concrete from the examples noted.

A scale of n from minus ten to positive ten was used to judge release (ease of removal and amount left on substrate), with n=0 being the release performance for untreated gum (control). A positive n value means release from the substrate was easier than for untreated gum, with the amount of gum left behind on the substrate equal to 1/n times that left by untreated gum (visual estimate). A negative n value means release from the substrate was more difficult that for untreated gum, with the amount of gum left behind on the substrate equal to |n| times that left for untreated gum (visual estimate).

TABLE II
Test Results for various concentrations of “Best Performing”
Non-Crosslinked Alkyl Dimethicone Example 1
Me₃SiO—[Me₂SiO]₁₈—[MeRSiO]₉—SiMe₃ [R = (CH₂)₁₁CH₃]

| % mass conc | Release Performance |
|---|---|
| 0 (control) | 0 |
| 0.5% | 0 |
| 1.0% | 0 |
| 2.0% | 2 |
| 4.0% | 8 |
| 6.0% | 9 |

While the minimum effective concentration for the “Best Performing” Non-Crosslinked Alkyl Dimethicone Example 1 Additive is revealed to be between 2.0% to 4.0% by mass in the total chewing gum formulation, it may in fact be significantly lower depending on the method of how the additive is combined into the chewing gum formulation. For all the studies herein, a concentration of 4% by mass in the total chewing gum formulation is used for both non-crosslinked alkyl dimethicone additives and crosslinked alkyl dimethicone crosspolymer additives as they all employ the same method of combining the additive into the gum as described above.

Test III: Effect of the “Best Performing” Non-Crosslinked Alkyl Dimethicone Example 1 Additive Me₃SiO-[Me₂SiO]₁₈-[MeRSiO]₉—SiMe₃ where R=(CH₂)₁₁CH₃ on Adhesion During Processing, Flavor Duration, and Chewability Using Wrigley's Doublemint Gum

Procedure: The gum used for testing was Wrigley's Doublemint Gum sticks. The additive used was “best performing” Example 1 Me₃SiO-[Me₂SiO]₁₈-[MeRSiO]₉—SiMe₃ [R═(CH₂)₁₁CH₃]. For Test A, four sticks of gum were each cut into quarters and placed into a 150 mL beaker. Sufficient additive was then added to achieve a 4% concentration by mass. The contents of the beaker were then heated to 120-125° C. in a mineral oil bath. The gum softened and the contents of the beaker were vigorously stirred with a spatula for 2 minutes so as to thoroughly mix the alkyl-dimethicone into the gum. The gum was then removed from the glass beaker with a stainless steel spatula while still hot and pressed into a pancake on a clean hard black-resin countertop and allowed to cool (these operations mimic manufacturing processing). An amount of the additive treated gum equivalent to one stick of gum was then chewed for 20 minutes. The procedure for Test B was identical to that for Test A (it was heated and processed as in Test A) except that no alkyl dimethicone additive was employed.

TABLE III
Test Results for Effect of 4% “Best Performing” Non-Crosslinked Alkyl
Dimethicone Example 1 Additive Me₃SiO—[Me₂SiO]₁₈—[MeRSiO]₉—SiMe₃ where R =
(CH₂)₁₁CH₃ on Adhesion During Processing, Flavor Duration, and Chewability

| Test | Adhesion During Processing | Flavor Duration | Chewability |
|---|---|---|---|
| A (with Example | Gum released with ease from | Initial sensation of | Cud was softer than |
| 1 additive) | glass beaker with no residual | flavor was intense. | untreated gum, |
| | gum adhering to the glass. | Mint sensation was | easier to chew. |
| | Gum released with ease from | detectable for the | Blowing of a |
| | stainless steel spatula and | entire 20 minute | bubble was |
| | resin countertop. | chew. | possible. |
| B (no additive) | Gum adhered to glass beaker | Initial sensation of | Cud became hard |
| | (impossible to remove all of | sugar was intense. | and difficult to |
| | the gum from the beaker). | Mint sensation was | chew after 2 |
| | The gum released with | not detectable after | minutes. Blowing |
| | difficulty from the stainless | 2 minutes of | of a bubble was not |
| | steel spatula and resin- | chewing. | possible. |
| | countertop. | | |

Preparation and Testing of Alkyl Dimethicone Crosspolymer Additives.

### Example 6

### Alkyl Dimethicone Crosspolymers of formula Me₃SiO-[Me₂SiO]₁₈-[meRSiO]₉₋ₓ-[Me(CH₂CH₂SiMe₂O_{1/2})SiO]ₓ—SiMe₃ where R=(CH₂)₁₁CH₃

1-dodecene (0.177-q mol) and silanic hydrogen intermediate Me₃SiO-[Me₂SiO]₁₈-[MeHSiO]₉—SiMe₃ (40.0 g, 0.177 mol) were combined in a 150 mL beaker and stirred with a stainless steel paddle stirrer at 500 rpm and heated in an 85° C. mineral oil bath. 30 μL of catalyst was added, causing a very rapid exotherm to between 130-150° C. The reaction was then allowed to stir in the 85° C. oil bath for 2 hours. Next, q/2 mol of 1,3-divinyltetramethyldisolxane was added and an additional 30 μL of catalyst was added, yielding no substantial exotherm. The reaction was allowed to stir in the 85° C. oil bath for an additional 20 hours, or until a gel formed. The following crosspolymers were produced.

They are all crosslinked versions of the “best performing” non-crosslinked alkyl dimethicone additive Example 1 (Me₃SiO-[Me₂SiO]₁₈-[MeRSiO]₉—SiMe₃ where R=(CH₂)₁₁CH₃, LSB=8.4) with increased amount of crosslinking function replacing dodecyl function.

Alkyl Dimethicone Crosspolymers of Formula Me₃SiO-[Me₂SiO]₁₈-[MeRSiO]₉₋ₓ-[Me(CH₂CH₂SiMe₂O_{1/2})SiO]ₓ—SiMe₃ where R=(CH₂)₁₁CH₃

| | | | | Viscosity | |
|---|---|---|---|---|---|
| Example | q (mol) | x value | state | (cSt @ 25° C.) | LSB |
| 6a | 0.004 | 0.2 | Fluid | 182 | 8.6 |
| 6b | 0.008 | 0.4 | Fluid | 277 | 8.8 |
| 6c | 0.012 | 0.6 | Fluid | 364 | 9.0 |
| 6d | 0.014 | 0.8 | Fluid | 800 | 9.2 |
| 6e | 0.020 | 1.0 | Gel | — | 9.4 |

Test IV: Results for Alkyl Dimethicone Crosspolymer Additives to Chewing Gum

Additives Example 6d and 6e were tested in an identical manner to Example 1 in test I. In both cases, the results were superior to that of “best performing” non-crosslinked alkyl dimethicone additive Example 1. With reference to FIGS. 1a through 1c, and with regard to release from cement, alkyl dimethicone crosspolymers additive Examples 6d and 6e yielded a reduced amount of additive residue left behind on the cement (upon removal of the chewed cud) that was almost undetectable visually for sample 6e (FIG. 1c), whereas “best performing” non-crosslinked alkyl dimethicone additive Example 1 yielded a very obvious stain of additive on the cement upon removal of the chewed cud (FIG. 1a).

In addition, whereas at 4% in the gum, non-crosslinked Example 1 Additive yielded a dramatically modified chewability (a softer chew than for the unadulterated gum and the ability to blow a bubble, not possible for the unadulterated gum), 4% crosslinked Examples 6d and 6e Additives yielded a chew indistinguishable from the unadulterated gum and an identical inability to blow a bubble to that of the unadulterated gum. With regard to release of the chewed cud from carpet, whereas “best performing” non-crosslinked Example 1 Additive did not allow from complete removal of the chewed cud from olefin carpet after 3 pulls (Test 1), crosslinked Examples 6d and 6e yielded complete removal of the chewed cud from olefin carpet with just one pull. Finally, both “best performing” non-crosslinked Example 1 Additive and crosslinked Additives 6d and 6e yielded a detectable mint sensation on the tongue during chewing for the entire 20 minute period of the chew, whereas gum without any of these additives yielded no mint detectable mint sensation on the tongue within 2-7 minutes of the 20 minute chew period. Elongated flavor release provided by both non-crosslinked alkyl dimethicone and alkyl dimethicone crosspolymers may be due to an imbuing of the cud with a silophilic (silicone-like) character which in turn helps to drive the flavor components out of the cud during chewing (it is well know to those practiced in the art of silicones that the majority of both hydrophilic and hydrophobic organic compounds, including flavor components, have very little solubility in silicone).

Therefore, while both non-crosslinked alkyl dimethicone additives of the prior art and the alkyl dimethicone crosspolymers of the present disclosure may be said to result in elongated flavor duration or flavor release from the cud during chewing, it is only the alkyl dimethicone crosspolymers of the present disclosure that do so with significantly reduced softening of the cud (reduced plasticization), further reduction of adhesion of the chewed cud from environmental and dental surfaces, and less residue left behind on environmental surfaces upon removal of the cud from said surfaces, relative to non-crosslinked alkyl dimethicone additives.

Less softening of the cud, further reduction of adhesion of the cud to environmental and dental surfaces, and less residue left behind on environmental surfaces upon removal of the cud from said surfaces brought about by alkyl dimethicone crosspolymers of the present disclosure relative to non-crosslinked alkyl dimethicones are effects due, it is believed, to the crosslinking which, by increasing molecular size and structural complexity, lead to a greater affinity of the alkyl dimethicone crosspolymer additive for the cud and less mobility within the cud (and thus less plasticization).

It is believed that the crosslinks in the foregoing formulations further aid in successful clearing of regulatory hurdles for approval as a direct food additive. Crosslinking in polymeric substances helps to render them indigestible and thus inert. For example, dietary fiber, an indigestible substance, is a crosslinked polysaccharide (carbohydrate polymer); yeast is rendered indigestible by chemical crosslinking; and polysaccharides within plant cell walls are rendered indigestible by chemical bonding (crosslinking) to lignin.

The foregoing description merely explains and illustrates the disclosure and the disclosure is not limited thereto except insofar as the appended claims are so limited, as those skilled in the art who have the disclosure before them will be able to make modifications without departing from the scope thereof.

What is claimed is:

1. A gum for chewing comprising:
a gum base; and
an additive comprising at least one alkyl dimethicone crosspolymer, which are defined as polymeric compounds having Formula I=(R¹R²R³SiO)([CH₃]₂SiO)ₓ(CH₃R⁴SiO)_{y}(CH₃XSiO)_{z}(SiR⁵R⁶R⁷), where R¹, R², R³, R⁴, R⁵, R⁶, R⁷ can be an alkyl chain from 1-50 carbons in length and is at least one of linear, branched, saturated, or unsaturated; X can be any functionality that serves to crosslink one polymer chain of Formula I to another polymer chain of Formula I, and is preferably but not limited to (—CH₂CH₂)(CH₃)₂SiO_{1/2}; x≧1; y≧1; z>0.

2. The gum of claim 1 wherein z is ≧0.1 and ≦2.1.

3. The gum of claim 1 wherein the organization of said alkyl dimethicone crosspolymers is at least one of random or blocked with respect to the ([CH₃]₂SiO), (CH₃R⁴SiO), and (CH₃XSiO) units.

4. The gum of claim 1 wherein the siloxane backbone is branched via incorporation of one or more (CH₃SiO₂) and/or (SiO₃) units.

5. The gum of claim 1 wherein a portion of the alkyl dimethicone crosspolymer is cyclic in nature.

6. The gum of claim 1 wherein the additive comprises between 0.01% to 90% by mass of the gum.

7. The gum of claim 6 wherein the additive comprises between 0.05% to 40% by mass of the chewing gum.

8. The gum of claim 7 wherein the additive comprises between 0.5% and 8% by mass of the chewing gum.

9. The gum of claim 1 further comprising at least one water soluble portion.

10. The gum of claim 9 wherein the at least one water soluble portion comprises at least one of the group consisting of: sugar, syrup, or aspartame, saccharin, sucralose, sorbitol, natural and artificial sweeteners.

11. The gum portion of claim 1 wherein the gum base further includes at least one of the group consisting of: terpene resins, rosin resins, esterfied or hydrogenated and function as plasticizers to the elastomers; monoglycerides, lecithins, hydrogenated vegetable oils, waxes, mineral fillers, calcium carbonate and talc.

12. The gum porting of claim 1 further comprising at least one flavor.

13. The gum portion of claim 12 wherein the at least one flavor is selected from the group consisting of: natural and artificial flavorings, spearmint, peppermint, and fruit flavors.

14. A method of formulating a gum for chewing comprising the steps of:
providing at least one gum base;
providing an additive comprising at least one alkyl dimethicone crosspolymer, which are defined as polymeric compounds having Formula I=(R1R2R3SiO)([CH3]2SiO)x(CH3R4SiO)y(CH3XSiO)z(SiR5R6R7), where R1, R2, R3, R4, R5, R6, R7 can be an alkyl chain from 1-50 carbons in length and is at least one of linear, branched, saturated, or unsaturated; X can be any functionality that serves to crosslink one polymer chain of Formula I to another polymer chain of Formula I, and is preferably but not limited to (—CH2CH2)(CH3)2SiO1/2; x>1; y>1; z>0; and
mixing the at least one gum base with the additive.

15. The method of claim 14 further comprising the step of:
providing at least one water soluble portion; and
the step of mixing further comprises the step of mixing the at least one water soluble portion.

16. The method of claim 15 further comprising the step of:
providing at least one flavor; and
the step of mixing further comprises the step of mixing the at least one flavor.

17. The method of claim 14 wherein z is >0.1 and <2.1.

18. The method of claim 14 wherein the organization of said alkyl dimethicone crosspolymers is at least one of random or blocked with respect to the ([CH3]2SiO), (CH3R4SiO), and (CH3XSiO) units.

19. The method of claim 14 wherein the siloxane backbone is branched via incorporation of one or more (CH3SiO2) and/or (SiO3) units.

20. The method of claim 14 wherein a portion of the alkyl dimethicone crosspolymer is cyclic in nature.

21. The method of claim 14 wherein the step of providing the additive further comprises the step of providing the additive in a quantity of between 0.01% and 90% by weight of the gum.

22. The method of claim 21 wherein the step of providing the additive further comprises the step of providing the additive in a quantity of between 0.5% and 8% by weight of the chewing gum.
